(19) United States
(12) Patent Application Publication
(10) Pub. No.: US 2020/0209820 A1
(43) Pub. Date: Jul. 2, 2020

(54) SYSTEM AND METHOD FOR IMPROVING THE ENERGY MANAGEMENT OF HVAC EQUIPMENT

(71) Applicant: BERT LABS PRIVATE LIMITED, Bengaluru (IN)

(72) Inventors: Rohit KOCHAR, Bangalore (IN); Apurva ANKLESHWARIA, Bangalore (IN); Amit BHANJA, Bangalore (IN); Jayesh JAIN, Bangalore (IN); Ravikumar SUBRAMANIAN, Bangalore (IN); Yasin KHAN, Bangalore (IN)

(73) Assignee: BERT LABS PRIVATE LIMITED, Bengaluru (IN)

(21) Appl. No.: 16/726,055

(22) Filed: Dec. 23, 2019

(30) Foreign Application Priority Data
Dec. 26, 2018 (IN) 201841049091

(51) Int. Cl. G05B 19/042

(52) U.S. Cl. CPC G05B 19/042; G05B 2219/2614

(57) ABSTRACT

Disclosed herein is a system and a method for improving the energy management of HVAC equipment. The system comprising: a plurality of sensors distributed in a building for sensing a set of parameters including environmental information, thermal zone information, energy consumption information, operational parameter information and field information from the building; a network for connecting the plurality of sensors; a server includes a hybrid platform with physics based simulation model and machine learning model for processing and controlling the parameters of the HVAC equipment.

### FIELD OF DISCLOSURE

The disclosure relates to a system and a method for monitoring and controlling the Heating, Ventilation and Air Conditioning (HVAC) equipment to improve the energy management of the HVAC equipment.

### BACKGROUND

Heating, Ventilation and Air Conditioning (HVAC) equipment are used to maintain the thermal comfort of users within a building. Offices, hospitals, hotels, retail stores, factories, and industrial premises are some examples. While the objective is being met, the method deployed have significant room to be energy efficient.

The HVAC equipment influences conditions in multiple rooms of the building with a centralized source of heated or cooled air (for example, chiller or boiler) and a plurality of ducts, dampers (that is, air handing unit (AHU)) to manage airflow throughout the building. Many of the HVAC equipment includes a controller to enable and disable components of the HVAC equipment in order to control one or more environmental conditions within the building. These environmental conditions include, but are not limited to, temperature, humidity, Carbon dioxide levels, Volatile organic compounds (VOCs) and ventilation. In many cases, HVAC controllers include or have access to one or more sensors and use the measured values of parameters provided by the one or more sensors to control the one or more HVAC components to achieve the desired program, set environmental conditions, or reduce the energy consumption.

The integration of many equipment including, but not limited to, chillers, pumps, air handling units, cooling towers and inverters consumes energy. The system utilizes various inputs to control the energy consumption of the buildings. The system includes hardware or software stack wherein the hardware stack comprises sensor devices and the software stack comprise the process and methods for processing the operational inputs collected by the sensor devices.

In conventional systems, few methods have been proposed to address the aforementioned problems.

US Patent Application NO. 20160061469 to David H. Albonesi, et al. titled “Building power management systems” relates to a system for managing power in a building which includes HVAC. The system comprises a network of sensors to detect the building environment data, energy data and set of power states of the building zone and self-learning, distributed predictive control to optimize the control sequence and power state settings. The optimized control sequence is interacted with occupants of building as a suggestion and recommendation via an interface.

US Patent Application NO. 20140249876 to Leon L. Wu, et al. titled “Adaptive Stochastic Controller for Energy Efficiency and Smart Buildings” relates to a technique for improving energy efficiency of HVAC in a building energy management system. The system includes network connected data collectors to sense environmental values (such as temperature, carbon dioxide) and to collect energy values through electric meters. A Total Property Optimizer (TPO) tool of the system integrates simulation models and machine learning algorithms to manage the building's energy consumption. The system further includes a dashboard to display metrics and recommendations to users.

Though there are a number of systems and methods disclosed for improving the energy efficiency of the HVAC equipment of buildings, all of them either have considered HVAC as two separate systems, namely high side and low side, for controlling and monitoring or there are cases where low side machine parameters have been considered for high side controlling.

The challenge with such an approach is that it inherently works on a predefined rules or/logic wherein one control strategy is given a preference over another. However, there is no system to monitor and control the HVAC equipment (high and low side) as a single system and decision on controls being taken on real time information.

Hence, there is a need for a system for controlling the HVAC equipment as a whole and reduce energy consumption as it controls the high side (, but not limited to, equipment such as chiller, water pumps, cooling towers) or the low side (, but not limited to, AHUs fan speed, indoor room set point, chilled water flow rate) or combination of the two while maintaining comfortable indoor conditions.

### OBJECTIVE OF THE DISCLOSURE

The primary objective of the present disclosure is to improve the energy management of a Heating, Ventilation and Air conditioning (HVAC) system of the building while maintaining a preferred indoor environment.

Another objective of the present disclosure is to provide hierarchical layers for enabling the estimation of true load of the building in real time, various operational parameters of HVAC equipment in real time and transmission of the information to achieve energy efficiency of HVAC equipment.

Yet another objective of the present disclosure is to provide an artificial intelligence powered platform using a three pronged control strategy on a remote server, on an on-premise server and edge device.

Yet another objective is to reduce complexity in terms of deployment of a number of devices for controlling the HVAC equipment.

### SUMMARY

To achieve at least one of the objectives mentioned above, the present disclosure provides a system for improving energy management of HVAC equipment, comprising: a plurality of sensors distributed in at least one room of a building; a network for connecting the plurality of sensors; a remote server or on-premise server or edge device for collecting and storing the parameters from the sensor and a platform for processing the parameters, computing control strategies and outputting signals to control the operational parameters of the HVAC equipment.

According to the present disclosure, the hierarchical layers are used to receive information from the sensors and perform various controlling actions to enable real time or near real time energy management. This is achieved while also reducing energy consumption of power control devices in the buildings.

In accordance to the present disclosure, the method for improving the energy management of HVAC equipment comprising: collecting measured values of a set of parameters including environmental information, energy consumption information and operational parameter information from a plurality of sensors; connecting the plurality of sensors through a network; storing the collected parameters from the sensors at a remote server or an on-premise server or edge device; a platform for processing the measured values of the parameters and computing control strategies and outputting control signals for controlling the HVAC equipment.

In one aspect of the present disclosure, the sensors are used to collect the indoor or outdoor environmental information, energy consumption and operational parameter information of various HVAC equipment. This information establishes the overall energy information of the system and operational parameter information from the building.

In another aspect of the disclosure, the method of improving the energy management of HVAC equipment wherein the method includes a physics-based simulation model and a machine learning model to process the information. The method works on certain principles. For example, if the information is adequate the learning model takes the lead whereas the physics based simulation model takes the lead, if the information is limited. The power control devices receive commands from the remote server to control the operational parameters of HVAC or to provide recommendations or preventive measures.

Thus, disclosed is a system for improving energy management of HVAC equipment comprising a) a plurality of distributed sensors for sensing a set of parameters including environmental information, thermal zone information, energy consumption information and operational parameter information from the building, b) a network for connecting the sensors, c) a remote server or an on-premise server for collecting and storing the sensed values of the set of parameters through the network, d) a platform configured for processing the sensed values of the set of parameters and computing control strategies, wherein the platform resides in the remote server and on-premise server and performs the following actions i) detects irregularities of the HVAC equipment, ii) evaluates at least one control strategy for the HVAC equipment, and iii) selects one or more control strategy strategies for execution simultaneously.

Also disclosed is a method for improving energy management of HVAC equipment, the method comprising the steps of a) collecting sensed values of a set of parameters including environmental information, energy consumption information, and operational parameter information from a plurality of distributed sensors, b) connecting the sensors through a network for transmitting the collected sensed values of the set of parameters, c) storing the collected sensed values of the set of parameters from the sensors at a remote server or on-premise server, d, processing the stored sensed values of the set of parameters in a platform, computing control strategies for the HVAC equipment, and e) outputting and executing control parameters for the HVAC equipment.

These objectives and advantages of the present disclosure will become evident from the following detailed description taken in conjunction with the accompanying drawings.

### BRIEF DESCRIPTION OF THE DRAWINGS

The objective of the present disclosure will now be described in detail concerning the accompanying drawings, in which:

FIG. 1 represents a schematic diagram of the overall HVAC control architecture;

FIG. 2 represents a few example scenarios for the working model of the platform of remote server or on-premise server or base station/edge device; and

FIG. 3 represents the network architecture of the HVAC equipment.

### REFERENCE NUMERALS

100: Overall HVAC control architecture
110: Sense and Connect
112: Sensors
112A: Environmental sensors
112B: Energy consumption detecting sensors
112C: Operational parameters sensor
112D: Field device sensors
114: Connecting nodes
116: Base station/Edge device
118A, 118B, 118C: Router
119A, 119B: Modem
120A: Remote server
120B: On-Premise server
122: Hybrid platform
122A: Physics based simulation model
122A-1: Building model
122A-2: Machine system/sub-system 1D/2D/3D modelling
122B: Machine learning model
124: Database
126A: Application server
126B: Web server
128: Load balancer
129: Firewall
130: ACT
132: Power control devices
134: Dashboard display
136: Control Action
136A: Chiller Plant manager
136B: DDC Panel
138: Internet

### DETAILED DESCRIPTION

The present disclosure discloses a system and method for improving energy efficiency of HVAC for a building. The integrated system of HVAC includes, but is not limited to, chiller, air handling unit, cooling towers, and pumps. The system disclosed in this disclosure is implemented using an artificial intelligence platform.

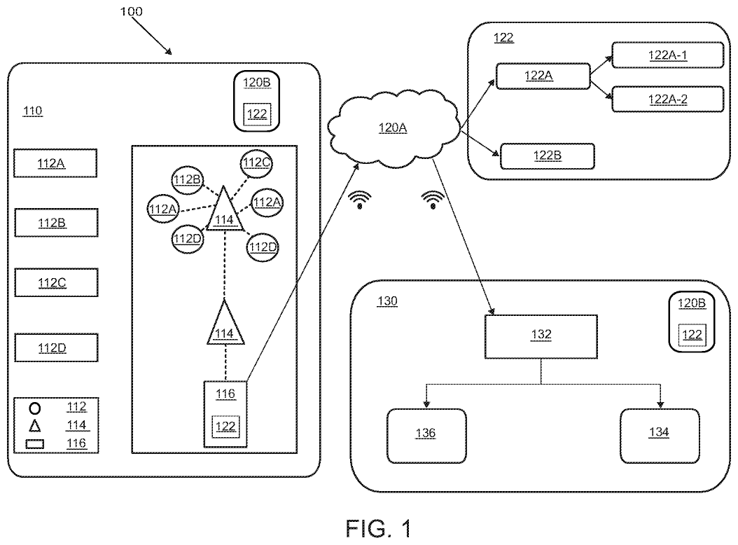

FIG. 1 depicts the schematic diagram of an overall HVAC control architecture (100) of the present disclosure. The disclosed architecture collaboratively controls both high and low sides that is, of HVAC equipment. The integrated HVAC equipment includes: a plurality of sensors (112), a network and a remote server (120A) or an on-premise server (120B) or an edge device (116) with a platform (122) to improve energy efficiency. The system also, includes a two-layered hierarchical system in which one for sense and connect phase (110) and another for action phase (130). The sense and connect phase (110) comprise the sensors (112) or IOT devices networked in a wireless manner.

The sensors (112) collect the environment information and controls the energy consuming HVAC equipment. The wireless networked sensors (112) are categorized into four categories as shown in FIG. 1:

Environmental sensors (112A) that use digital protocol in order to get the information from in-built sensors for (Relative Humidity (RH), Carbon dioxide (CO2), Volatile Organic Compounds (VOC) and other parameters. The environmental parameters also include, but not limited to, the outdoor weather conditions, building thermal comfort and air quality conditions. These parameters act as an essential part for giving the maximum input of the environmental surroundings in and out of the buildings or factories.

1. Energy consumption detecting sensors (112B) to detect the real-time energy consumption of the various HVAC equipment including, but not limited to, Chiller, Air Handling Unit, Pumps, and Cooling Towers. These parameters establish the overall energy consumption of the HVAC equipment.
2. Operational parameters sensors (112C) to monitor the status of the operational parameters of all HVAC equipment including, but not limited to, Chiller, Air Handling Unit, Pumps and Cooling towers (CT). It is a device having hardware and software protocol to monitor and control the equipment (AHU, Chiller, CT and Pumps) parameters.
3. Field Device sensors (112D) to read the Flow-Thermal data at various points in the HVAC equipment starting form AHU supply or return line to water pump lines, decoupler lines, across chiller Evaporator, condenser and not limited to these equipment.

These networked sensors (112) send the collected information to the remote server (120A) which is represented in the second layer (130) of the FIG. 1. The information processed by the remote server (120A) are described below in detail.

In one embodiment, the sensors (112) are connected to connecting nodes (114). Number of connecting nodes (114) are connected to a base station (116) which communicates to the remote server (120A) via the network (138).

In accordance to FIG. 1, the layer 2 is action phase (130) which comprises the remote server (120A), but not limited to, a cloud server or on-premise server (120B) or edge device (116). The action phase (130) is referred as ACT. The information gathered from the wireless networked sensors (112) are sent to the cloud server (120A) through a wireless network (138). This information is evaluated by using a platform (122) that utilizes the physics based simulation model (122A) and machine learning model (122B). The physics based simulation model (122A) and machine learning model (122B) are combined and developed as a hybrid platform (122) which performs calculations to derive various possible control strategies. It evaluates each action with respect to its potential to save energy of overall HVAC equipment which includes, but not limited to, chiller, pumps, cooling towers and AHUs. Also, it detects real-time irregularities in the functioning of HVAC equipment which includes, but not limited to, chiller, pumps, cooling towers and AHUs, to improve mechanical, electrical performance of HVAC equipment at all times, in turn improving energy savings. The evaluated results are sent to the power control devices (132). Now, the power control devices (132) react to the energy management system of buildings. The process is repeated till platform (122) becomes mature enough and thus reduces the dependency on real time sensor data and further improving the ability of the system to bring energy efficiency even when one or more sensors are not operational.

In accordance with the present disclosure, the collected parameters from the sensors are stored and processed independently as per requirement in the following servers such as remote server (120A), on-premise server (120B) and base station/edge device (116). Based on the requirement, each server computes the different set of control activities to be performed at three different levels (that is, within the base station, inside the premise, at remote level) in order to bring higher granularity and higher coverage. This type of control activities is used to improve the reliability and speed of controls to bring higher energy efficiency improvement and human comfort.

In another embodiment, the base station/edge device (116) acts as a mini server which performs an immediate control action based on the sensor (112) information.

In another embodiment, the platform (122) works on certain principles. For example, If the information is adequate, the machine learning model (122B) takes the lead. The physics based simulation model (122A) takes the lead if the information is limited.

In another embodiment, the hybrid platform (122) also accesses the information, but not limited to, sensors (112) information from past, past HVAC equipment usage information, HVAC's current load information, other zone temperature and various predefined operational and safety boundaries for the equipment for making control strategies of the HVAC equipment.

In yet another embodiment, the physics based simulation model (122A) includes, but are not limited to, energy model for the building (122A-1), one-dimensional system model of the HVAC equipment and three-dimensional computational fluid dynamics (CFD) analysis (122A-2).

In yet another embodiment, the sensors (112), connecting nodes (114) and base station (116) (that is within the building) are connected in various network topologies, but not limited to, a mesh topology and a star topology. The communication between various components (112, 114, 116) is made using various network protocols such as, but not limited to, Low-Power Wireless Personal Area Network, Personal Area Network (PAN), Local Area Network (LAN), Wide Area Network (WAN) or wireless network. The communication medium used in this communication is short-range or long-range or medium, but not limited to, radio frequency (RF), Bluetooth, and Zigbee.

In a further embodiment, the communication between the sensors and connect phase (110), remote server (120A) or on-premise server (120B) or edge device (116) and ACT phase (130) is made using wireless communication protocol or internet (138) and so on, for example.

In a further embodiment, the information in the cloud server (120A) of action phase (130) is used to predict the energy the consumption of the HVAC equipment. The proposed system is also configured to control (136) the equipment of the overall HVAC equipment based on the evaluation of consumed energy.

In some embodiments, the power control devices (132) are connected to a dashboard display (134) which displays real-time monitoring and real-time energy data forecasting.

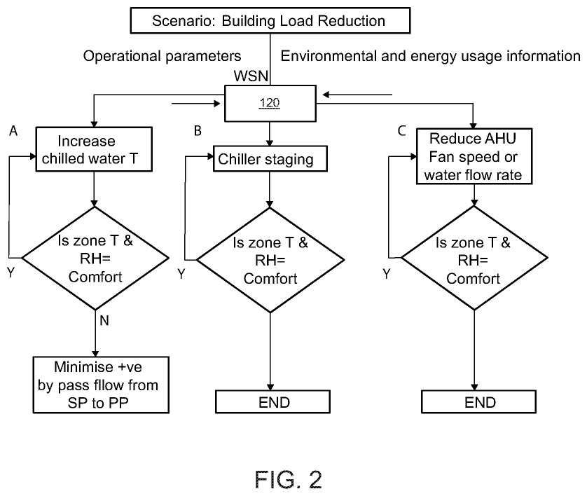

FIG. 2 illustrates one example to explain the hybrid platform (122) in the remote server (120A) or on-premise server (120B) or edge device/base station (116) which has the ability to evaluate multiple feasible control options for a given practical scenario such as a reduction in building power load. There could be more control options, but for the purposes of demonstration, a few possible actions of the proposed system are described below

a. The first action could be to increase the chilled water temperature. Then, the hybrid platform (122) in the cloud server (120A) predicts the new revised energy consumption for this action and delivers the energy consumption value to the device to operational parameters sensors (112C) to the HVAC equipment.
b. The second action could be to determine the chiller staging levels, in case of multiple chillers, based on the real time health of the chiller and part load efficiency. It reduces the overall load on the chillers by utilising the staging mechanism instead of reducing the load on only one chiller to a certain level. This decision is taken to load multiple chillers by once again estimating the revised energy consumption and sharing the information with operational parameters sensors (112C).
c. The third action could be to decrease the AHU fan speed or reducing the water flow rate. Then, the hybrid platform (122) estimates the new revised energy consumption for the overall HVAC equipment and shares the information with operational parameters sensors (112C).
d. The final control action execution via operational parameters sensors (112C) could be a sequential or parallel execution of all the three actions mentioned above to minimize the overall HVAC system energy consumption.

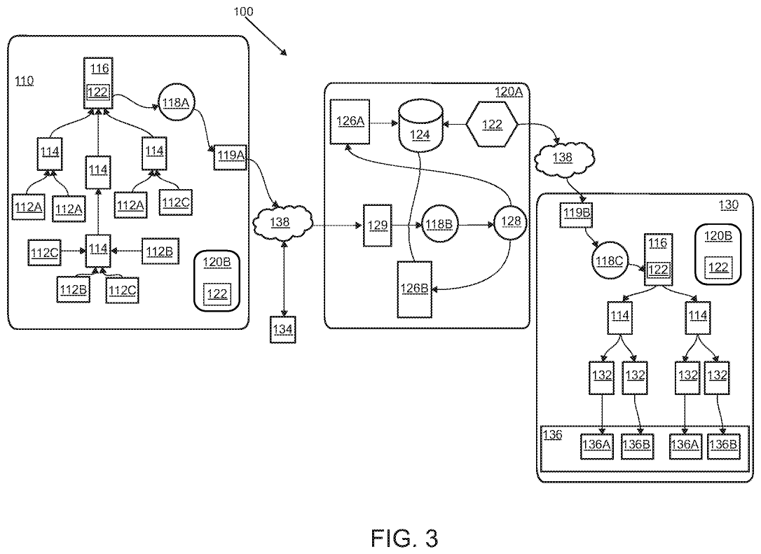

FIG. 3 illustrates diagrammatically, the network architecture of the present disclosure. The parameters which are obtained from the sensors (112) are sent as encrypted data packets (encrypted with the advanced encryption standard (AES) 128-bit encrypted packets with session key, for example) to the base station or edge device (116) via the connecting nodes (114). Then, the parameters are directed to the remote server (120A) from the base station (116) through the routers (118A) and modem (119A). The parameters are transmitted securely from sense and connect phase to ACT phase through the SSL. The SSL acts as a firewall (129) to prevent the intrusion and non-genuine activities inside the remote server (120A) or on-premise server (120B) or base station/edge device (116). The information of the parameters is sent to the classic load balancer (128) via the routers (118B) securely. The load balancer (128) balances the load across the remote server (120A) or on-premise server (120B). The router (118B) passes the information to the remote database (124) through the web server (126B) instances. The application server (126A) receives the information from the classic load balancer (128) and sends it to the remote database (124). The hybrid platform (122) processes the information, computes control strategies and output the controls to the HVAC equipment. The base station (116) at ACT phase (130) receives the controlling commands from the platform (122) and send the information to the branch nodes (114). Further, the information passes to the power control devices (132) from the branch nodes (114). The power control devices send the control commands to actuate the control action (136) in the HVAC equipment such as, but not limited to, chiller plant manager (136A) or direct digital control panel that is, DDC panel (136B). Also, the architecture has a dashboard display (134) in order to detect or monitor real-time irregularities of the HVAC equipment. The display (134) collects the information directly from sense and connect phase (110).

The disclosed architecture herein is oriented towards improving the energy management of HVAC equipment of buildings or commercial premises. It provides hierarchical network layers for managing the energy efficiency of HVAC equipment. It may also reduce the number of devices utilized and hence provide less complex architecture and thereby overcomes the bandwidth/latency related challenges associated with the flow of communication of big data.

While the foregoing written description of the disclosure enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure as claimed.

I/We claim:

1. A system for energy management of HVAC equipment comprises of:
a. a plurality of distributed sensors for sensing a set of parameters including environmental information, thermal zone information, energy consumption information and operational parameter information from the building;
b. a network for connecting the sensors;
c. a remote server or an on-premise server for collecting and storing the sensed values of the set of parameters through the network;
d. a platform configured for processing the sensed values of the set of parameters and computing control strategies, wherein the platform resides in the remote server and on-premise server and performs the following actions:
i. detects irregularities of the HVAC equipment;
ii. evaluates at least one control strategy for the HVAC equipment; and
iii. selects one or more control strategies for execution simultaneously.

2. The system as claimed in claim 1, wherein the sensors include environmental sensors, energy consumption sensors and operational parameters sensors.

3. The system as claimed in claim 1, wherein the sensors further include one or more field device sensors.

4. The system as claimed in claim 1, wherein the sensors are connected to connecting nodes to collect information from the sensors.

5. The system as claimed in claim 4, wherein the connecting nodes are connected to a base station which communicates with the remote server via the network.

6. The system as claimed in claim 5, wherein the base station includes the platform for collecting, storing, and processing the set of parameters from the sensors and computing an immediate control action.

7. The system as claimed in claim 1, wherein the platform includes a physics based simulation model and a machine learning model for processing the parameters.

8. A method for improving energy management of HVAC equipment, comprising the steps of:
a. collecting sensed values of a set of parameters including environmental information, energy consumption information, and operational parameter information from a plurality of distributed sensors;
b. connecting the sensors through a network for transmitting the collected sensed values of the set of parameters;
c. storing the collected sensed values of the set of parameters from the sensors at a remote server or on-premise server;
d. processing the stored sensed values of the set of parameters in a platform and computing control strategies for the HVAC equipment; and
e. outputting and executing control parameters for the HVAC equipment.

9. The method as claimed in claim 8, wherein the method is configured for detecting irregularities in the collected parameters of the HVAC equipment.

10. The method as claimed in claim 9, wherein the detected irregularities are displayed in a dashboard display.
